(19) United States
(12) Patent Application Publication
(10) Pub. No.: US 2025/0245383 A1
(43) Pub. Date: Jul. 31, 2025

(54) METHOD FOR DATA PROTECTION, ELECTRONIC DEVICE AND COMPUTER-READABLE STORAGE MEDIUM

(71) Applicant: SHENZHEN PAX SMART NEW TECHNOLOGY CO., LTD., Shenzhen, Guangdong (CN)

(72) Inventor: Aiping ZHOU, Shenzhen, Guangdong (CN)

(73) Assignee: SHENZHEN PAX SMART NEW TECHNOLOGY CO., LTD., Shenzhen, Guangdong (CN)

(21) Appl. No.: 18/022,939

(22) PCT Filed: Jul. 14, 2021
(86) PCT No.: PCT/CN2021/106158

§ 371 Date: Sep. 20, 2023

(30) Foreign Application Priority Data
Aug. 26, 2020 (CN) 202010871009.5

(51) Int. Cl. G06F 21/62

(52) U.S. Cl. CPC G06F 21/6254

(57) ABSTRACT

The present application relates to the technical field of computers, and provides a data protection method, including: selecting an obfuscation processing rule for performing a data obfuscation processing on the target data and an obfuscation processing parameter table adapted to the obfuscation processing rule, in response to receiving target data; and performing the data obfuscation processing on the target data according to the obfuscation processing rule and the obfuscation processing parameter table adapted to the obfuscation processing rule, so as to protect the target data. Since the computing resources consumed for performing the data obfuscation processing on data are far less than the computing resources consumed for performing secret key encryption on the data, so that the consumed computing resources for protecting the data may be reduced when the data is protected in a manner of performing the data obfuscation processing on the data.

### CROSS-REFERENCE TO RELATED APPLICATIONS

This application is a 35 U.S.C. § 371 national stage application of PCT patent application No. PCT/CN2021/106158, filed on Jul. 14, 2021, which claims priority to Chinese patent application No. 202010871009.5, filed on Aug. 6, 2020. The entire contents of which are incorporated herein by reference.

### FIELD

The present application relates to the technical field of computers, and more particularly, to a method for data protection, an electronic device and a computer-readable storage medium.

### BACKGROUND

Financial applications have extremely high requirements on data security, for example, personal information such as user's card numbers, user's telephone numbers, user's addresses, and the like cannot appear in a file or a database in the form of plaintext, or even cannot appear in a memory for a long time. Otherwise, the personal information is prone to be stolen by some malicious users and used for some illegal purposes.

In the related art, in order to protect data security, data is usually protected by a method of using a secret key to encrypt the data. However, since the data interacted with the user is usually stored in the memory, an access frequency of the memory is very high during a program execution process. Furthermore, since the method of using the secret key to encrypt data usually needs to consume more computing resources. Therefore, in the related art, it needs to consume huge computing resources if the data in the memory is protected by using the secret key to encrypt the data. As a result, in the related art, computing resources for protecting data in the memory need to be reduced.

### SUMMARY

One objective of the embodiments of the present application is to provide a temperature and pressure sensor and an electronic device, in order to solve a technical problem in the prior art that both a temperature detection device and a pressure detection device need to be assembled on an object to be detected, so that the electronic device is large in the structure and the size, and it is inconvenient to use the electronic device.

In the first aspect, a method for data protection implemented by an electronic device is provided, the method includes:

selecting an obfuscation processing rule for performing a data obfuscation processing on the target data and an obfuscation processing parameter table adapted to the obfuscation processing rule, in response to receiving a target data; and

performing the data obfuscation processing on the target data according to the obfuscation processing rule and the obfuscation processing parameter table adapted to the obfuscation processing rule, so as to protect the target data.

Furthermore, said selecting the obfuscation processing rule for performing the data obfuscation processing on the target data and the obfuscation processing parameter table adapted to the obfuscation processing rule, includes:

generating, according to a preset rule, an option code including rule indication information and parameter table indication information; wherein the rule indication information is used to indicate the obfuscation processing rule, and the parameter table indication information is used to indicate the obfuscation processing parameter table adapted to the obfuscation processing rule;

selecting the obfuscation processing rule indicated by the rule indication information, and selecting the obfuscation processing parameter table adapted to the obfuscation processing rule and indicated by the parameter table indication information.

Furthermore, said performing the data obfuscation processing on the target data according to the obfuscation processing rule and the obfuscation processing parameter table adapted to the obfuscation processing rule, includes:

determining a ranking of each of the plurality of obfuscation processing rules in response to a plurality of selected obfuscation processing rules; and

determining the target data as data to be obfuscated, and extracting a highest-ranked obfuscation processing rule from the plurality of obfuscation processing rules, and performing following processing steps, including: performing the data obfuscation processing on the data to be obfuscated using the extracted obfuscation processing rule and an obfuscation processing parameter table adapted to the extracted obfuscation processing rule; determining the obfuscated data as the data to be obfuscated, and extracting a highest-ranked obfuscation processing rule from unextracted obfuscation processing rules in response to a presence of the unextracted obfuscation processing rules in the plurality of obfuscation processing rules; and performing the processing steps cyclically.

Furthermore, said generating, according to the preset rule, the option code including the rule indication information and the parameter table indication information, includes:

generating the rule indication information for indicating the obfuscation processing rule according to a first preset rule, and generating the parameter table indication information for indicating the obfuscation processing parameter table according to a second preset rule; and

combining the rule indication information with the parameter table indication information to generate the option code.

Furthermore, said generating the rule indication information for indicating the obfuscation processing rule according to the first preset rule, includes:

assigning M different values to a preset array including M bytes, selecting values of first N bytes in the preset array, and determining a combination of the selected values of the first N bytes as the rule indication information; where one value in the selected values of the first N bytes is used to indicate one obfuscation processing rule; where each of the selected values is an integer ranging from 0 to (M−1), M and N are integers, and 0<N<M.

Furthermore, the rule indication information is a combination of values of the first N bytes in the preset array, and the values of the N bytes are N different integers; and

said generating, according to the second preset rule, the parameter table indication information for indicating the obfuscation processing parameter table, includes:

randomly generating a random number having a length of N bytes, and determining the generated random number as the parameter table indication information, wherein one byte of data is used to indicate one obfuscation processing parameter table; and

said combining the rule indication information with the parameter table indication information to generate the option code, includes:

traversing each byte of data in the random number having the length of N bytes, and performing, when the current byte of data is accessed, replacement operations including: selecting an unselected integer from the N integers, and replacing a low three-bit data of the current byte of data with a low three-bit data of the selected integer so as to obtain an operational byte data; where a high four-bit data of the obtained operational byte data is used for indicating the obfuscation processing parameter table, and the low three-bit data is used for indicating the obfuscation processing rule; and

determining a combination of obtained N operated byte data as the option code.

Furthermore, the obfuscation processing rule includes at least one of rules, including:

a rule for replacing characters included in a data with other characters;

a rule for performing a shift operation on the data;

a rule for performing an Exclusive OR on the data;

a rule for performing a coding operation on the data; and

a rule for assigning 1 to a first bit of data byte in bytes.

In the second aspect, an electronic device is provided in the embodiments of the present application. The electronic device includes a memory, a processor, and a computer program stored in the memory and executable by the processor; when executing the computer program, the processor is configured to implement the method for data protection.

In the third aspect, a non-transitory computer-readable storage medium is provided, the computer-readable storage medium stores a computer program, that, when executed by a processor of an electronic device, causes the processor of the electronic device to implement the method for data protection.

In the fourth aspect, a computer program product is provided in the embodiments of the present application, when the computer program product is executed on the electronic device, the electronic device is caused to perform any one of the method for data protection in the first aspect.

Compared with the related art, the embodiments of the present application have the following beneficial effects: since the computing resources consumed for performing data obfuscation processing on the data is far less than the computing resources consumed for data encryption using secret key. Thus, if the data is protected in the manner of performing data obfuscation processing on the data, the computing resources used for data protection can be reduced.

It can be understood that, regarding the beneficial effects of the second aspect, the third aspect, the fourth aspect and the fifth aspect, reference can be made to the relevant descriptions in the first aspect. The beneficial effects of the second aspect, the third aspect, the fourth aspect and the fifth aspect are not repeatedly described herein.

### BRIEF DESCRIPTION OF THE DRAWINGS

In order to describe the embodiments of the present application more clearly, a brief introduction regarding the accompanying drawings that need to be used for describing the embodiments or exemplary technology of the present application is given below. It is apparent that, the accompanying drawings described below are only some embodiments of the present application. A person of ordinary skill in the art may also obtain other drawings according to the current drawings without paying creative labor.

FIG. 1 illustrates a schematic flowchart of a method for data protection according to one embodiment of the present application;

FIG. 2 illustrates a schematic flowchart of a method for data protection according to another embodiment of the present application; and

FIG. 3 illustrates a schematic structural diagram of an electronic device according to one embodiment of the present application.

### DETAILED DESCRIPTION OF EMBODIMENTS

In the following descriptions, in order to describe but not intended to limit the present application, concrete details including specific system structure and technique are proposed to facilitate a comprehensive understanding of the embodiments of the present application. However, a person of ordinarily skill in the art should understand that, the present application can also be implemented in some other embodiments from which these concrete details are excluded. In other conditions, detailed explanations of method, circuit, device and system well known to the public are omitted, so that unnecessary details which are disadvantageous to understanding of the description of the present application may be avoided.

It should be understood that, when a term “comprise/include” is used in the description and annexed claims, the term “comprise/include” indicates existence of the described characteristics, integer, steps, operations, elements and/or components, but not exclude existence or adding of one or more other characteristics, integer, steps, operations, elements, components and/or combination thereof.

It should be further understood that, terms “and/or” used in the description and the annexed claims of the present application are referred to as any combination of one or a plurality of listed item(s) associated with each other and all possible items, and including these combinations.

As is used in the description and the annexed claims, a term “if”' may be interpreted as “when” or “once” or “in response to determination” or “in response to detection”. Similarly, terms such as “if it is determined that”, or “if it is detected that (a described condition or event)” may be interpreted as “once it is determined” or “in response to the determination” or “once it is detected that (the described condition or event)” or “in response to the detection (the described condition or event)”.

In addition, in the descriptions of the present application, terms such as “first” and “second”, “third”, etc., are only used for distinguishing purpose in description, but shouldn't be interpreted as indication or implication of a relative importance.

The descriptions of “referring to one embodiment” and “referring to some embodiments”, and the like as described in the specification of the present application means that a specific feature, structure, or characters which are described with reference to this embodiment are included in one embodiment or some embodiments of the present application. Thus, the sentences of “in one embodiment”, “in some embodiments”, “in some other embodiments”, “in other embodiments”, and the like in this specification are not necessarily referring to the same embodiment, but instead indicate “one or more embodiments instead of all embodiments”, unless there is a special emphasis in other manner otherwise. The terms “comprising”, “including”, “having” and their variations mean “including but is not limited to”, unless otherwise they are specially emphasized in other manner.

In order to describe the technical solutions of the present application, the technical solutions are described with reference to the following embodiments.

### Embodiment One

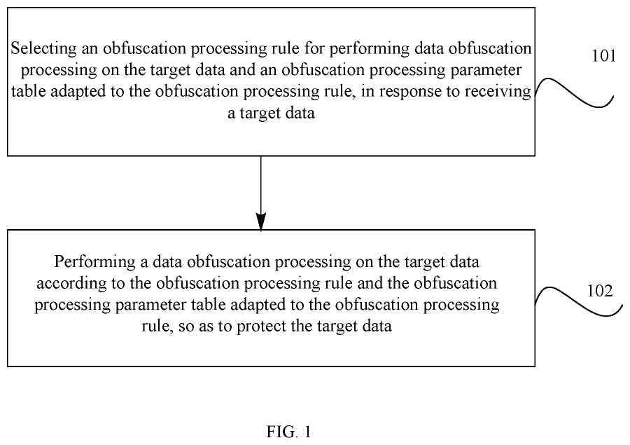

Referring to FIG. 1, a method for data protection is provided in one embodiment of the present application, the method for data protection includes:

At a step 101, an obfuscation processing rule for performing data obfuscation processing on a target data and an obfuscation processing parameter table adapted to the obfuscation processing rule are selected, in response to receiving the target data.

The target data generally refers to the data that needs to be protected. As an example, the target data may be a user's name, a user's age, a user's contact number, a user's address, and the like.

Data obfuscation processing generally refers to an operation of rewriting data and generating new data that is not readable by the user, but would not disturb the original logic of the data. Thus, data obfuscation processing is performed on the data, data leakage is not prone to occur, and the security of the data can be ensured.

The obfuscation processing rule generally refers to a rule for performing data obfuscation processing on the data. As an example, the obfuscation processing rule may be a rule for adding a preset value to the data to be obfuscated, or be a rule for directly replacing the data to be obfuscated into other data. The obfuscation processing parameter table generally refers to a table composed of parameters used for performing data obfuscation processing on the data. As an example, the obfuscation processing parameter table is a table for replacing one piece of data into another data. For a further example, if the obfuscation processing rule is a rule for directly replacing the data to be obfuscated into another data, in this condition, the obfuscation processing parameter table adapted to the obfuscation processing rule may be a table for replacing one piece of data into another data. If the data to be obfuscated is 5 and the value that is directly replaced with 5 in the obfuscation processing parameter table is 8, when the obfuscation processing rule and the obfuscation processing parameter table adapted to the obfuscation processing rule are used to perform data obfuscation processing on the data to be obfuscated, data 8 is obtained.

In an practical application, a plurality of obfuscation processing rules are provided, and each obfuscation processing rule generally has one or more obfuscation processing parameter tables matching with the obfuscation processing rule. In order to facilitate distinguishing the various obfuscation processing rules and the various obfuscation processing parameter tables, each of the obfuscation processing rules and each of the obfuscation processing parameter tables may be numbered in advance. For example, if five obfuscation processing rules are pre-stored, the obfuscation processing rules may be assigned with the following numbers: 1, 2, 3, 4, 5. For another example, if the obfuscation processing rule assigned with the number 1 has 2 optional obfuscation processing parameter tables, the obfuscation processing parameter tables may be assigned with the following numbers 1-1 and 1-2, respectively.

Herein, a plurality of optional obfuscation processing rules are provided, and one obfuscation processing rule is provided with a plurality of optional obfuscation processing parameter tables, so that the data is not prone to be cracked after data obfuscation processing has been performed on the data, and the data can be protected much better.

In this embodiment, an executive subject of the method for data protection may be a terminal device. The terminal device may be various electronic devices including, but not limited to, a smart phone, a tablet computer, a laptop portable computer, a desktop computer, and the like.

In this embodiment, the executive subject may receive various data. When receiving the target data, the executive subject may select one obfuscation processing rule from the plurality of obfuscation processing rules, and select an obfuscation processing parameter table from the obfuscation processing parameter tables adapted to the selected obfuscation processing rule. As an example, the executive subject may randomly select one obfuscation processing rule from the plurality of obfuscation processing rules, and randomly select an obfuscation processing parameter table from an obfuscation processing parameter tables adapted to the selected obfuscation processing rule.

At step 102, data obfuscation processing is performed on the target data according to the obfuscation processing rule and the obfuscation processing parameter table adapted to the obfuscation processing rule, so as to protect the target data.

In this embodiment, after the obfuscation processing rule that can be used to perform data obfuscation processing on the target data and the obfuscation processing parameter table adapted to the obfuscation processing rule are obtained, the executive subject may perform the data obfuscation processing on the target data by using the obfuscation processing rule and the obfuscation processing parameter table adapted to the obfuscation processing rule. For example, if the obfuscation processing rule is: replacing the characters included in the data to be obfuscated with the corresponding characters in the obfuscation processing parameter table. The data to be obfuscated is 123, the character corresponding to 1 in the obfuscation processing parameter table is 8, the character corresponding to 2 in the obfuscation processing parameter table is 4, and the character corresponding to 3 in the obfuscation processing parameter table is 0, after the data obfuscation processing is performed on the data to be obfuscated, 840 may be obtained.

According to the method for data protection in this embodiment, the computing resources consumed by performing data obfuscation processing on the data are far less than the computing resources consumed for performing secret key encryption on the data. Thus, when data protection is performed in the manner of performing data obfuscation processing on the data, the computing resources for the data protection may be reduced.

It needs be noted that, after the data obfuscation processing is performed on the target data, the obfuscated data obtained by performing the obfuscation processing, the serial number of the obfuscation processing rule, and the serial number of the obfuscation processing parameter table adapted to the obfuscation processing rule may be associated. In this way, if the obfuscated data obtained by performing obfuscation processing needs to be recovered into the target data, the obfuscation processing rule for data obfuscation processing and the obfuscation processing parameter table adapted to the obfuscation processing rule may be used to perform an inverse data obfuscation processing on the obfuscated data to obtain the target data. Here, the inverse data obfuscation processing generally refers to an operation of recovering the obfuscated data into data before operation of the data obfuscation processing.

In some optional implementations of this embodiment, said performing the data obfuscation processing on the target data according to the obfuscation processing rule and the obfuscation processing parameter table adapted to the obfuscation processing rule includes:

Step one: a ranking of each of the plurality of obfuscation processing rules is determined in response to the plurality of selected obfuscation processing rules.

Herein, if the number of the selected obfuscation processing rules is plural, the aforesaid executive subject may determine the ranking of each of the obfuscation processing rules. As an example, the executive subject may perform a random ranking on the plurality of obfuscation processing rules. As another example, since the obfuscation processing rules may be selected through the selection of the number of the obfuscation processing rules. Thus, the obfuscation processing rules may be ranked according to a distribution sequence of the numbers of the plurality of obfuscation processing rules. As a further example, if the numbers of the selected obfuscation processing rules are 4, 1, 0, and 2 in sequence, the obfuscation processing rule numbered 4 is ranked as 1, the obfuscation processing rule numbered 1 is ranked as 2, the obfuscation processing rules numbered 0 is ranked as 3, and the obfuscation processing rules numbered 2 is ranked as 4.

It needs be noted that, when the number of the selected obfuscation processing rules are plural, one obfuscation processing parameter table adapted to one selected obfuscation processing rules is selected.

Step two: the target data is determined as the data to be obfuscated, and a highest-ranked obfuscation processing rule is extracted from the plurality of obfuscation processing rules, and the following processing steps are performed: performing data obfuscation processing on the data to be obfuscated using the extracted obfuscation processing rule and the obfuscation processing parameter table adapted to the extracted obfuscation processing rule; in response to the presence of unextracted obfuscation processing rules in the plurality of obfuscation processing rules, determining the obfuscated data after the data obfuscation processing as the data to be obfuscated, and extracting a highest-ranked obfuscation processing rule from the unextracted obfuscation processing rules, and continuing to perform the processing steps.

Herein, for example, if the target data is data 0, there are two obfuscation processing rules, they are an obfuscation processing rule ranked as 1 and recorded as a first obfuscation processing rule, and an obfuscation processing rule ranked as 2 and recorded as a second obfuscation processing rule, respectively. In this condition, the data 0 may be determined as the data to be obfuscated, the highest-ranked first obfuscation processing rule and the obfuscation processing parameter table adapted to the first obfuscation processing rule are selected to perform data obfuscation processing on the data 0 to obtain the obfuscated data 1. Then, the data 1 is used as the data to be obfuscated, and the second obfuscation processing rule and the obfuscation processing parameter table adapted to the second obfuscation processing rule are selected to perform data obfuscation processing on the data 1 to obtain the obfuscated data 2.

In this implementation, multiple obfuscation processing rules are used to perform data obfuscation processing on the target data for multiple times, thus, it can be further guaranteed that the target data is not prone to being leaked, and the security of the target data can be further guaranteed.

In some optional implementations of this embodiment, selecting the obfuscation processing rule for performing data obfuscation processing on the target data and the obfuscation processing parameter table adapted to the obfuscation processing rule, includes:

First, an option code including rule indication information and parameter table indication information is generated according to a preset rule.

The rule indication information is used to indicate an obfuscation processing rule, and the parameter table indication information is used to indicate an obfuscation processing parameter table adapted to the obfuscation processing rule.

The preset rule may be a preset rule used for generating the option code. In practice, since each obfuscation processing rule generally has one unique number, and each obfuscation processing rule may have a plurality of adapted obfuscation processing parameter tables, and each obfuscation processing parameter table adapted to the obfuscation processing rule generally has one unique number. Thus, as an example, the aforesaid preset rule may be implemented as follows: first, a number is randomly selected from the numbers of all obfuscation processing rules (e.g., A is selected from A, B, and C), and is recorded as the first number. Then, a number (e.g., 5 is selected from 1, 2, 3, 4, 5) is selected from the numbers of all of the obfuscation processing parameter tables adapted to the obfuscation processing rule having the first number, and is recorded as the second number. Finally, the combination of the first number and the second number (e.g., A-5) is used as an option code. In this situation, the rule indication information included in the option code may be the first number, and the parameter table indication information included in the option code may be the second number.

Then, the obfuscation processing rule indicated by the rule indication information is selected, and the obfuscation processing parameter table indicated by the parameter table indication information and adapted to the obfuscation processing rule is selected.

Herein, after obtaining the rule indication information for indicating the obfuscation processing rule and the parameter table indication information for indicating the obfuscation processing parameter table, the executive subject may directly select the obfuscation processing rule indicated by the rule indication information, and select the obfuscation processing parameter table indicated by the parameter table indication information and adapted to the obfuscation processing rule.

In this implementation, the obfuscation processing rule and the obfuscation processing parameter table adapted to the obfuscation processing rule are selected by generating the option code, which facilitates implementing a rapid selection of the obfuscation processing rule and the obfuscation processing parameter table adapted to the obfuscation processing rule, so that an improvement of a selection speed is facilitated.

In some optional implementations of this embodiment, generating the option code including the rule indication information and the parameter table indication information according to the preset rule includes: generating the rule indication information for indicating the obfuscation processing rule according to a first preset rule, and generating the parameter table indication information for indicating the obfuscation processing parameter table according to a second preset rule. The rule indication information and the parameter table indication information are combined to generate the option code.

The first preset rule may be a preset rule. As an example, the first preset rule may be implemented as: randomly generating a value, performing remainder calculation on the randomly generated value and the number of total obfuscation processing rules, and determining the obtained remainder as rule the indication information. The second preset rule may also be a preset rule. As an example, the second preset rule may be implemented as: randomly selecting a value from a plurality of preset values, and determining the selected value as the parameter table indication information. In practice, the first preset rule and the second preset rule may be identical or different.

In this implementation, for each piece of target data that needs to be protected, the rule indication information and the parameter table indication information are generated, so that the option code is obtained, an obfuscation processing rule and an obfuscation processing parameter table which are different from each other can be selected to perform data obfuscation processing on the target data, so that the obfuscated target data after data obfuscation processing is not prone to be cracked, and the target data can be better protected.

In some optional implementations of this embodiment, generating the rule indication information for indicating the obfuscation processing rule according to the first preset rule includes:

M different values are assigned to a preset array having M bytes, values of the first N bytes are selected in the preset array, and the combination of the selected values of the N bytes is determined as the rule indication information. Where, each value is used to indicate one obfuscation processing rule, the values are integers ranged from 0 to M−1, M and N are integers, and 0<N<M.

Herein, for example, if M=5, N=4, the executive subject may randomly assign 5 values (i.e., 0, 1, 2, 3, 4) to the array having 5 bytes, and one value is assigned to one byte of the array. If the values allocated to the 5 bytes of the array are 4, 2, 1, 0, and 3, respectively, the values of the first four bytes of the array may be selected to obtain the rule indication information 4210. It needs to be noted that, since one byte has 8 bits, the value of this byte is usually represented by the 8 bits of the byte. In particular, when a value 5 is assigned to the byte, the value may be specifically expressed as 00000101.

In practice, M is the total number of obfuscation processing rules. It needs be noted that, the value of M bytes contained in the array in default is empty.

In this implementation, the selection of the obfuscation processing rule from M obfuscation processing rules is implemented by allocating values to the preset array containing the M bytes, which is prone to be operated and realized, the computational complexity may be reduced, and the computing resources may be saved.

In some optional implementations of this embodiment, if the rule indication information is the combination of values of N bytes, the values of the N bytes are N different integers.

In this condition, said generating the parameter table indication information for indicating the obfuscation processing parameter table according to the second preset rule includes: randomly generating a random number having a length of N bytes, and determining the generated random number as the parameter table indication information. One byte of data is used to indicate a unique obfuscation processing parameter table.

Herein, the executive subject may randomly generate a random number having a length of N bytes. As an example, if N=4, in this condition, a random number of 4 bytes may be generated. Specifically, the random number of the 4 bytes may be represented as 0x78 A1390 C. In this condition, the random number is represented by 8 bits, the first byte of the random number may be 01111000, the second byte of the random number may be 10100001, the third byte of the random number may be 00111001, and the fourth byte of the random number may be 00001100. In this condition, the generated random number of the 4 bytes may be directly determined as the parameter table indication information. In practice, some bits (e.g., high four bits) in each byte of the random number of the 4 bytes may be set to be used to indicate the obfuscation processing parameter table. As a further example, the random number of the first byte of the random number is 01111000, if the high four bits of the first byte is used for indicating the obfuscation processing parameter table, the high four bits are 0111, which equalizes 7. Thus, the high four bits may indicate the obfuscation processing parameter table numbered 7. It needs be noted that, in the related art, the first four bits of byte data are high bits, and the last four bits of the byte data are low bits. For example, in the byte data of 11000111, 1100 are high four bits, 0111 are low four bits.

Said combining the rule indication information with the parameter table indication information to generate the option code, includes:

First, data of each byte in the random number having the length of N bytes is traversed, and when the data of the current byte is accessed, the following replacement operations are performed: an unselected integer is selected from N integers, and the low three-bit data of the current byte of data is switched into low three-bit data of the selected integer to obtain the operated byte data. Where the high four-bit data of the obtained operated byte data is used to indicate the obfuscation processing parameter table, and the low three-bit data of the operated byte data is used to indicate the obfuscation processing rule. Then, the combination of the obtained N operated byte data is determined as the option code.

Herein, for example, if N=4 and a random number having a length of N bytes is 0x78A1390 C, a binary expression of the random number may be:

01111000 10100001 00111001 00001100

If the values of the N bytes of the rule indication information are 4, 2, 1, 0, respectively, the binary expression of the data of the N bytes of the rule indication information may be:

00000 100 00000 010 00000 001 00000 000

The spaces between the byte data are only for the convenience of reading. In practical application, there is no space for separating the multiple byte data. In addition, overstriking of few bits in the byte data is for the purpose of intuitively describing the change of the switching operation performed on the byte data.

When the executive subject traverses the first byte of data (01111 000) of the random number, the current byte is the first byte, in this condition, the switching operation may be performed on the data of the first byte, the switching operation is specifically implemented as: selecting an integer from four integers of 4, 2, 1 and 0; if integer 4 (i.e., 00000100) is selected, the low three-bit data of the first byte of data may be switched to a low three-bit data of the integer 4 so as to obtain 01111 100. The obtained high four-bit data “0111” in 01111 100 is 7, and the high four-bit data may be used to indicate an obfuscation processing parameter table numbered 7. The low three-bit data is “100”, and the low three-bit data may be used to indicate an obfuscation processing rule numbered 4.

Four new byte data may be obtained after the executive subject has traversed the four bytes of the random number. In this condition, the obtained four new byte data may be determined as the option code. The binary expression of the obtained four new byte data may be:

01111 100 10100 010 00111 001 00001 000

In practice, in order to facilitate operation and implementation, the executive subject generally switches the data of the first byte of the random number to the first integer of the rule indication information, switches the data of the second byte of the random number to the second integer of the rule indication information, switch the data of the third byte of the random number to the third integer of the rule indication information, etc.

In this implementation, the parameter table indication information used for indicating the obfuscation processing parameter table is generated in the manner of random number, so that the target data is not prone to be cracked after data obfuscation processing is performed on the target data, which facilitates implementation of better protection of the target data. In addition, a bit switching operation is performed between the bytes of the random number and the integers used for indicating the obfuscation processing rules, such that the obfuscation processing rule and the obfuscation processing parameter table adapted to the obfuscation processing rule can be presented by means of one byte data, the obtained option code occupies a few storage resources, conservation of storage resources is facilitated.

In optional implementations of the embodiments of the present application, the obfuscation processing rule may include, but is not limited to, at least one of the rules listed below: rule 1 for replacing characters included in the data into other characters. rule 2 for performing a shift operation on data; rule 3 for performing an Exclusive OR operation on data; rule 4 for performing an encoding operations on data; rule 5 for assigning 1 to a first bit of data byte in bytes.

Regarding the rule 1, if the obfuscation processing rule is the rule for replacing the characters included in the data with other characters, the obfuscation processing parameter table adapted to the obfuscation processing rule may be a table for replacing the characters included in data with other characters. Herein, for the convenience of description, a rule for replacing characters included in data into other characters is recorded as a byte replacement rule, and a table for replacing characters included in the data with other characters is recorded as a replacement table.

For example, the form of the replacement table may be specifically listed as below:

TABLE 1

| m | 8 | 0 | 2 | u | 1 | 9 | 4 | 6 | 3 |
|---|---|---|---|---|---|---|---|---|---|
| 0 | 1 | 2 | 3 | 4 | 5 | 6 | 7 | 8 | 9 |

The replacement table has two rows of data. Herein, the byte replacement rule may be implemented as follows: if data obfuscation processing is performed on the original data to be obfuscated, the characters included in the original data are replaced with the corresponding characters in the first row of data of the replacement table. On the contrary, if an inverse obfuscation processing is performed on the obfuscated data, the characters included in the obfuscated data are replaced with the corresponding characters in the second row of data of the replacement table.

Furthermore, for example, if the original data to be obfuscated is 1286, the characters included in the data are 1, 2, 8, and 6. In this condition, the character 1 may be replaced with the character 8 corresponding to the character 1 in the first row of data of the replacement table, the character 2 is replaced with the character 0 corresponding to the character 2 in the first row of data of the replacement table, the character 8 is replaced with the character 6 corresponding to the character 8 in the last row of data of the replacement table, the character 6 is replaced with the character 9 corresponding to the character 6 in the second row of data of the replacement table. In this way, acquisition of obfuscated data 8069 can be realized by performing data obfuscation processing on the data 1286 to be obfuscated. Herein, an operation of performing inverse obfuscation processing on the obfuscated data 8069 to obtain the original data 1286 is basically the same as an operation of performing obfuscation processing on the original data 1286 to obtain the obfuscated data 8069, so that the inverse obfuscation processing operation is not repeatedly described here.

It needs be noted that, since the replacement table is randomly generated by a program, the contents of the replacement table may be updated regularly. Moreover, there may be a plurality of replacement tables adapted to the byte replacement rule. Thus, by replacing the characters included in the original data with the corresponding characters in the replacement table using the byte replacement rule and one replacement table adapted to the byte replacement rule, the original data can be protected from data leakage, so that the security protection of the original data is guaranteed.

Regarding the rule 2, if the obfuscation processing rule is a rule for performing a shift operation on the data, the obfuscation processing parameter table adapted to the obfuscation processing rule may be a table for performing the shift operation on the data. Herein, for the convenience of description, the rule for performing the shift operation on data is recorded as a bit offset rule, and a table for performing a shift operation on data is recorded as an offset table.

For example, a form of the offset table may be listed below:

TABLE 2

| 5 | 8 | 9 | 2 | 7 | 1 | 0 | 4 | 6 | 3 |
|---|---|---|---|---|---|---|---|---|---|
| 0 | 1 | 2 | 3 | 4 | 5 | 6 | 7 | 8 | 9 |

The offset table has two rows of data. Herein, the bit offset rule may be implemented as follows: if the data obfuscation processing is performed on the original data to be obfuscated, the number of offset bits corresponding to the length of the original data is searched from the first row of data in the offset table. If the number of the offset bits is an odd number, a right shift operation for the offset bits is cyclically performed on the original data. If the number of offset bits is an even number, a left shift operation for the offset bits is cyclically performed on the original data. If inverse obfuscation processing is performed on the obfuscated data, the number of offset bits corresponding to the length of the obfuscated data is searched from the first row of data in the offset table. If the number of offset bits is an odd number, the left shift offset operation for the offset bits is cyclically performed for the obfuscated data. If the number of offset bits is an even number, the right shift offset operation for the offset bits is cyclically performed on the obfuscated data.

As a further example, if the original data to be obfuscated is 0x1286, the binary expression of the data is 0001 0010 1000 0110, and the length of the original data is 2 bytes. It can be found from the last row of data of the offset table that the number of offset bits corresponding to 2 is 9, 9 is an odd number, and the right-shift operation is cyclically performed on the original data by 9 bits, and a binary expression of 0000 1100 0010 0101 may be obtained. In other words, 0X0C25 is obtained. If an inverse obfuscation processing is performed on the obfuscated data subsequently, the length of the obfuscated data is 2, too. Thus, it may be found from the first row of data of the offset table that the number of offset bits corresponding to 2 is 9, 9 is an odd number, and the left shift operation is cyclically performed on the obfuscated data by 9 bits, and a binary expression of 0001 0010 1000 0110 can be obtained. That is, the original data 0X1286 is obtained. It needs to be noted that, the symbol “0x” used in the present application is a descriptor for describing hexadecimal data in the art.

It needs be noted that, since the offset table is randomly generated by the program, the contents of the offset table may be updated regularly, and there may be a plurality of offset tables adapted to the bit offset rule. Therefore, by performing the shift operation on the original data using the bit offset rule and one offset table adapted to the bit offset rule, the original data can be protected from data leakage, the security protection of the original data is ensured.

Regarding the rule 3, if the obfuscation processing rule is a rule for performing an Exclusive OR (XOR) operation on the data, the obfuscation processing parameter table adapted to the obfuscation processing rule may be a table for performing the Exclusive OR operation on the data. Herein, for the convenience of description, a rule for performing Exclusive OR operation on data is recorded as an Exclusive OR rule, and a table for performing Exclusive OR operation on data is recorded as an XOR table.

For example, a form of the Exclusive OR table may be listed below:

TABLE 3

| 8 | 9 | 2 | 7 | 1 | 0 | 4 | 6 | 3 |
|---|---|---|---|---|---|---|---|---|
| 1 | 2 | 3 | 4 | 5 | 6 | 7 | 8 | 9 |

The Exclusive OR table has two rows of data. Herein, the Exclusive OR rule may be implemented as follows: if the data obfuscation processing is performed on the original data to be obfuscated, Exclusive OR data corresponding to the length of the original data is searched from the last row of data of the Exclusive OR table, and an Exclusive OR operation is performed using the Exclusive OR data and the original data. If an inverse obfuscation processing is performed on the obfuscated data, the Exclusive OR data corresponding to the length of the obfuscated data is searched from the first row of data of the Exclusive OR table, and the Exclusive OR operation is performed by using the Exclusive OR data and the obfuscated data. Where, an operator of the Exclusive OR operation is ⊕, and an Exclusive OR operation rule is 0⊕0=0, 0⊕1=1, 1 ⊕0=1, 1⊕1=0.

As a further example, if the original data to be obfuscated is 0x03, the binary expression of the data is listed below:

0000 0011.

In this condition, the length of the original data is 1 byte. It can be found from the first row of data of the Exclusive OR table that the Exclusive OR data corresponding to 1 is 8. An exclusive OR operation may be performed on the original data 0000 0011 using the binary expression 0000 1000 of the Exclusive OR data 8, and a binary expression 0000 1011 can be obtained. In other words, 0x0B is obtained. If the inverse obfuscation processing is performed on the obfuscated data subsequently, the length of the obfuscated data is 1, too. An exclusive OR data 8 corresponding to 1 can be searched from the last row of data of the offset table, and the exclusive OR operation is performed on the obfuscated data 0000 1011 using the binary expression 0000 1000 of the Exclusive OR data 8, and a binary expression 0000 0011 can be obtained. In other words, the original data 0X03 is obtained.

It needs be noted that, since the Exclusive OR table is randomly generated by the program, the contents of the Exclusive OR table may be updated regularly, and there may be a plurality of Exclusive OR tables adapted to the Exclusive OR rule. Thus, the Exclusive OR operation is performed on the original data using the Exclusive OR rule and one Exclusive OR table adapted to the Exclusive OR table rule, so that the original data can be protected from being easily leaked, the security protection of the original data is ensured.

Regarding the rule 4, if the obfuscation processing rule is a rule for performing an encoding operation on the data, the obfuscation processing parameter table adapted to the obfuscation processing rule may be a table for encoding data. Herein, for the convenience of description, a rule for performing a coding operation on data is recorded as a coding rule, and a table for performing a coding operation on data is recorded as a coding table.

For example, a form of the encoding table may be specifically listed below:

TABLE 4

| u | I | C | g | J | Q | ] | e | T | K | b | j | H | U | O | B | 5 |
|---|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 | 16 |

The coding table has two rows of data. Herein, the encoding rule may be implemented as follows: if a data obfuscation processing is performed on the original data to be obfuscated, first, every three 8-bit data of the original data is segmented into four 6-bit data. Then, two bits of 0 are added to high bit of each of the four 6-bit data to generate four 8-bit data. Then, for each new 8-bit data, the decimal numerical value of each of the new 8-bit data is replaced with the corresponding characters in the first row of data of the coding table. Finally, each of the characters obtained by replacement is switched into hexadecimal data. If an inverse obfuscation processing is performed on the obfuscated data, first, each byte data included in the obfuscated data is switched into characters, and then the characters are replaced with the corresponding decimal numerical value in the second row of data of the encoding table. Then, the decimal numerical value obtained through replacement is switched into a binary number, then, two high bit bits 0 are removed. Finally, all binary data obtained by removing the two high bit bits 0 are combined in bytes to obtain the original data.

It needs be noted that, the first row of data in the coding table is usually randomly disorganized and generated by using visible characters. In particular, 64 visible characters may be selected to randomly generate the first row of data. The coding table is merely exemplary, not all of the coding tables are listed due to space limitation.

As a further example, if the original data to be obfuscated is 0x10A20C, the binary expression of the data is 00010000 10100010 00001100

First, the data is segmented into four 6-bit data, then, two bits 0 are added to the high bit of each of the four 6-bit data, so that four new 8-bit data can be obtained, which are listed as follows: 00000100 00001010 00001000 00001100. Then, the first new 8-bit data 00000100 is switched into decimal to obtain a value 4, the second new 8-bit data 00001010 is switched into decimal to obtain a value 10, the third new 8-bit data 00001000 is switched into decimal to obtain a value 8, and the fourth new 8-bit data 00001100 is switched into decimal to obtain a value 12. Then, the value 4 is replaced with J in the first row of data of the coding table, the value 8 is replaced with T in the first row of data of the coding table, the value 10 is replaced with b in the first row of data of the coding table, the value 12 is replaced with H in the first row of data of the coding table. Finally, the obtained JbTH is switched into hexadecimal, and data ox4A 62 54 48 is obtained. In this condition, the obfuscated data is ox4A 62 54 48.

It needs be noted that, since the encoding table is randomly generated by the program, the contents of the encoding table may be updated regularly, and there may be a plurality of encoding tables adapted to the encoding rule. Thus, encoding operation is performed on the original data by using the encoding rule and one encoding table adapted to the encoding table rule, such that the original data can be protected from data leakage, the security protection of the original data is ensured.

For rule 5, if the obfuscation processing rule is a rule for assigning 1 to a first bit of data byte in bytes, the obfuscation processing parameter table adapted to the obfuscation processing rule may be a table for assigning 1 to the first bit of data byte in bytes. Herein, for the convenience of description, a rule for assigning 1 to the first bit of data byte in bytes is recorded as a rule for randomly assigning 1 to the first bit, and a table for assigning 1 to the first bit of data byte in bytes is recorded as a value assignment table.

For example, a form of the value assignment table may be specifically listed below:

TABLE 5

| u | I | C | g | J | Q | ] | e | T | K | b | j | H | U | O | B | 5 |
|---|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 | 16 |

Herein, the value assignment table is similar to the aforesaid coding table. Herein, the rule for randomly assigning 1 to the first bit may be implemented as follows: if data obfuscation processing is performed on the original data to be obfuscated, a decimal data of the byte data included in the original data is switched into the corresponding characters in the first row of data of the value assignment table. Then, the first bit of the binary expression of the obtained characters is assigned to 1. If inverse obfuscation processing is performed on the obfuscated data, the first bit of the binary data which has the value assignment of 1 is reassigned to 0. Then, the characters corresponding to the data having the first bit of 0 are replaced with the corresponding decimal value in the second row of data of the value assignment table. Then, the decimal value is switched into the binary to obtain the original data.

It needs be noted that, since the first bit of each character is 0, the values of the first bits of a plurality of characters may be randomly assigned to 1 in the obfuscation process. In the inverse obfuscation process, the original data may be obtained by assigning values of first bits of all data to 0.

As a further example, if the original data is 0x04 0A 08 0C, the decimal data of byte data 0X04 is 4, the decimal data of byte data 0x08 is 8, the decimal data of byte data 0x0C is 12. Herein, the byte data 0x04 included in the original data may be switched into J in the first row of data of the value assignment table, the byte data 0X0A included in the original data may be switched into b in the first row of data of the value assignment table, the byte data 0X08 included in the original data may be switched into T in the first row of data of the value assignment table, the byte data 0X0C included in the original data may be switched into H in the first row of data of the value assignment table. In this way, a character string JbTH may be obtained.

A hexadecimal expression of the character string JbTH is 0x4A 62 54 48.

The binary expression of the character string JbTH is 01001010 01100010 01010100 01001000. An operation of assigning 1 to the first bit of the binary expression of the character string JbTH. If the operation of assigning 1 is performed on first bits of the first byte and the third byte, a binary expression of 11001010 01100010 11010100 01001000 can be obtained. In this condition, the obtained data is 0xCA 62 D4 48.

It needs be noted that, since the value assignment table is randomly generated by the program, the contents of the value assignment table may be updated regularly, and there may be a plurality of value assignment tables adapted to the rule for randomly assigning 1 to the first bit. Thus, the operation of assigning 1 to the first bit of data byte is performed on the original data using the rule for randomly assigning 1 to the first bit and one value assignment table adapted to the rule for randomly assigning 1 to the first bit, so that the original data can be protected from data leakage easily, the security protection of the original data is ensured.

It needs be noted that, for one certain original data to be obfuscated, one of the aforesaid five rules may be used to perform data obfuscation processing. As an alternative, various rules may be used to perform duplicated data obfuscation processing on the original data simultaneously. When various rules are used to perform duplicated data obfuscation processing on the original data, the original data may be further protected from data leakage, so that the security of the original data may be further improved.

### Second Embodiment

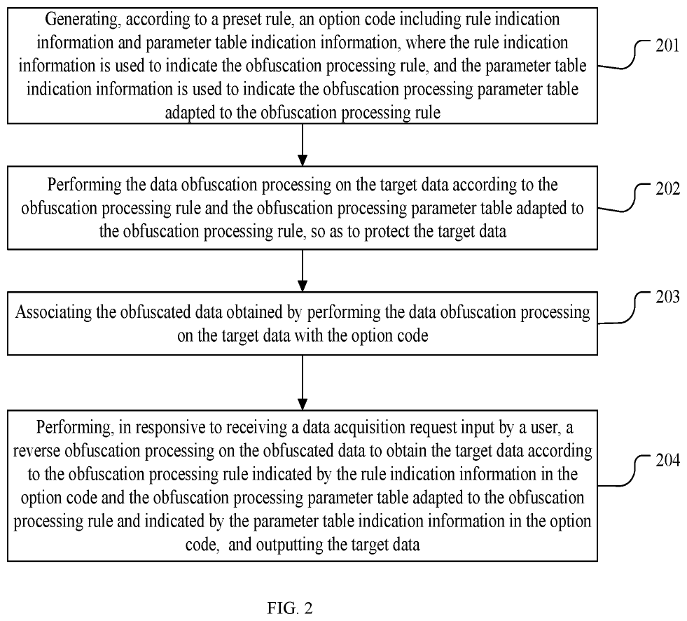

Another method for data protection is further provided in one embodiment of the present application, this embodiment is a further description of the first embodiment. Regarding the same or similar part between the second embodiment and the first embodiment, reference can be made to the relevant descriptions in the first embodiment, and the details are not repeatedly described herein. Referring to FIG. 2, the method for data protection in this embodiment includes:

At step 201, an option code including rule indication information and parameter table indication information is generated according to a preset rule, an obfuscation processing rule indicated by the rule indication information is selected, and an obfuscation processing parameter table indicated by the parameter table indication information and adapted to the obfuscation processing rule is selected, in response to receiving a target data.

The rule indication information is used to indicate an obfuscation processing rule, and the parameter table indication information is used to indicate an obfuscation processing parameter table adapted to the obfuscation processing rule.

In this embodiment, the operation of generating the option code is basically the same as the operation for generating the option code described above, thus, the details of the operation of generating the option code are not repeatedly described here. After obtaining the option code including the rule indication information and the parameter table indication information, the executive subject may directly select an obfuscation processing rule indicated by the rule indication information, and select an obfuscation processing parameter table indicated by the parameter table indication information and adapted to the obfuscation processing rule.

At step 202, a data obfuscation processing is performed on the target data according to the obfuscation processing rule and the obfuscation processing parameter table adapted to the obfuscation processing rule, so as to protect the target data.

In this embodiment, the detailed operations of the step 202 are basically the same as the operations in the step 102 in the embodiment shown in FIG. 1, and thus are not repeatedly described here.

At step 203, the obfuscated data obtained by performing the data obfuscation processing on the target data is associated with the option code.

In this embodiment, the executive subject may associate the obfuscated data with the option code. As an example, the executive subject may use the option code as header data of the obfuscated data, so as to associate the obfuscated data with the option code.

At step 204, in response to receiving a data acquisition request input by a user for acquiring the target data, an inverse obfuscation processing is performed on the obfuscated data to obtain the target data according to the obfuscation processing rule indicated by the rule indication information in the option code and the obfuscation processing parameter table indicated by the parameter table indication information in the option code, and the target data is output.

The aforesaid data acquisition request may be the request for acquiring the target data.

In this embodiment, the executive subject may receive a data acquisition request input by the user. After receiving the data acquisition request, the executive subject may perform the inverse obfuscation processing on the obfuscated data. In particular, the obfuscation processing rule indicated by the rule indication information in the option code may be selected, and the obfuscation processing parameter table adapted to the obfuscation processing rule and indicated by the parameter table indication information in the option code may be selected. The inverse obfuscation processing is performed on the obfuscated data to obtain the target data according to the selected obfuscation processing rule and the selected obfuscation processing parameter table adapted to the selected obfuscation processing rule.

After obtaining the target data, the executive subject may output the obtained target data. For example, the target data may be presented through a display screen.

It needs be noted that, if various obfuscation processing rules are simultaneously used to perform duplicated data obfuscation processing on the target data, when the inverse obfuscation processing is performed on the obfuscated data, the various obfuscation processing rules may be used to perform inverse obfuscation processing on the obfuscated data in a reverse order to obtain target data. For example, if the target data is data 0, there are two obfuscation processing rules which are the first obfuscation processing rule and the second obfuscation processing rule, respectively. The process of performing the data obfuscation processing on the target data includes: the first obfuscation processing rule and the obfuscation processing parameter table adapted to the first obfuscation processing rule are selected to perform data obfuscation processing on data 0 to obtain obfuscated data 1. Then, the second obfuscation processing rule and the obfuscation processing parameter table adapted to the second obfuscation processing rule are selected to perform data obfuscation processing on data 1 to obtain obfuscated data 2. In this case, the obfuscated data is data 2, and the process of performing inverse obfuscation processing on the obfuscated data may be implemented as follows: the second obfuscation processing rule and the obfuscation processing parameter table adapted to the second obfuscation processing rule are selected to perform inverse obfuscation processing on data 2 to obtain data 1; then, the first obfuscation processing rule and the obfuscation processing parameter table adapted to the first obfuscation processing rule are selected to perform inverse obfuscation processing on data 1 to obtain the target data 0.

In this embodiment, the inverse obfuscation processing is performed on the obfuscation data by using the obfuscation processing rule and the obfuscation processing parameter table which are the same as the obfuscation processing rule and the obfuscation processing parameter table for performing the data obfuscation processing on the target data, so that the obfuscated data can be quickly and accurately restored to the target data.

### Third Embodiment

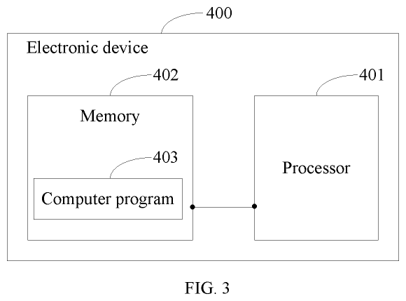

FIG. 3 illustrates a schematic structural diagram of an electronic device 400 provided by one embodiment of the present application. As shown in FIG. 4, the electronic device 400 in this embodiment includes: at least one processor (only one processor is shown in FIG. 3), a memory 402 and a computer program 403 (e.g., data protection procedure) stored in the memory 402 and executable by the at least one processor 401. When executing the computer program 403, the processor 401 is configured to implement the steps of any one of the embodiments of the various methods for data protection.

The electronic device 400 may be a computing device such as a server, a desktop computer, a tablet computer, a cloud server and a mobile terminal, etc. The electronic device 400 may include but is not limited to: the processor 401, the memory 402. A person of ordinary skill in the art can understand that, FIG. 3 is only one example of the electronic device 400, but should not be constituted as limitation to the electronic device 400. More or less components than the components shown in FIG. 3 may be included. As an alternative, some components or different components may be combined; for example, the electronic device 400 may also include an input and output device, a network access device, a bus, etc.

The so-called processor 401 may be a central processing unit (Central Processing Unit, CPU), and may also be other general purpose processor, digital signal processor (Digital Signal Processor, DSP), application specific integrated circuit (Application Specific Integrated Circuit, ASIC), field-programmable gate array (Field-Programmable Gate Array, FGPA), or some other programmable logic devices, discrete gate or transistor logic device, discrete hardware component, etc. The general purpose processor may be a microprocessor. As an alternative, the processor may also be any conventional processor, or the like.

The memory 402 may be an internal storage unit of the electronic device 400, such as a hard disk or a memory of the electronic device 400. The memory 402 may also be an external storage device of the electronic device 400, such as a plug-in hard disk, a smart media card (Smart Media Card, SMC), a secure digital (Secure Digital, SD) card, a flash card equipped on the electronic device 400. Furthermore, the memory 402 may not only include the internal storage unit of the electronic device 400 but also include the external memory of the electronic device 400. The memory 402 is configured to store the computer program, and other procedures and data needed by the electronic device 400. The memory 402 can also be configured to store data that has been output or being ready to be output temporarily.

In the aforesaid embodiments, the descriptions of the various embodiments are emphasized respectively. Regarding a part of one embodiment which has not been described or disclosed in detail, reference can be made to relevant descriptions in other embodiments.

The person of ordinary skill in the art may understand that, the elements and algorithm steps of each of the examples described in connection with the embodiments disclosed herein may be implemented in electronic hardware, or in combination with computer software and electronic hardware. Whether these functions are implemented by hardware or software depends on the specific application and design constraints of the technical solution. The skilled people could use different methods to implement the described functions for each particular application, however, such implementations should not be considered as going beyond the scope of the present application.

The foregoing embodiments are only intended to explain the technical solutions of the present application, rather than limiting the technical solutions of the present application. Although the present application has been described in detail with reference to these embodiments, a person of ordinary skilled in the art should understand that, the technical solutions disclosed in the embodiments may also be amended, some technical features in the technical solutions may also be equivalently replaced. The amendments or the equivalent replacements don't cause the essence of the corresponding technical solutions to be deviated from the spirit and the scope of the technical solutions in the embodiments of the present application, and thus should all be included in the protection scope of the present application.

1. A method for data protection implemented by an electronic device, comprising:
selecting an obfuscation processing rule for performing a data obfuscation processing on the target data and an obfuscation processing parameter table adapted to the obfuscation processing rule, in response to receiving a target data; and
performing the data obfuscation processing on the target data according to the obfuscation processing rule and the obfuscation processing parameter table adapted to the obfuscation processing rule, so as to protect the target data.

2. The method according to claim 1, wherein said selecting the obfuscation processing rule for performing the data obfuscation processing on the target data and the obfuscation processing parameter table adapted to the obfuscation processing rule comprises:
generating, according to a preset rule, an option code including rule indication information and parameter table indication information; wherein the rule indication information is used to indicate the obfuscation processing rule, and the parameter table indication information is used to indicate the obfuscation processing parameter table adapted to the obfuscation processing rule; and
selecting the obfuscation processing rule indicated by the rule indication information, and selecting the obfuscation processing parameter table adapted to the obfuscation processing rule and indicated by the parameter table indication information.

3. The method according to claim 1, wherein said performing the data obfuscation processing on the target data according to the obfuscation processing rule and the obfuscation processing parameter table adapted to the obfuscation processing rule comprises:
determining a ranking of each of the plurality of obfuscation processing rules in response to a plurality of selected obfuscation processing rules; and
determining the target data as data to be obfuscated, and extracting a highest-ranked obfuscation processing rule from the plurality of obfuscation processing rules, and performing following processing steps, including: performing the data obfuscation processing on the data to be obfuscated using the extracted obfuscation processing rule and an obfuscation processing parameter table adapted to the extracted obfuscation processing rule; determining the obfuscated data as the data to be obfuscated, and extracting a highest-ranked obfuscation processing rule from unextracted obfuscation processing rules in response to a presence of the unextracted obfuscation processing rules in the plurality of obfuscation processing rules; and performing the processing steps cyclically.

4. The method according to claim 2, wherein said generating, according to the preset rule, the option code including the rule indication information and the parameter table indication information comprises:
generating the rule indication information for indicating the obfuscation processing rule according to a first preset rule, and generating the parameter table indication information for indicating the obfuscation processing parameter table according to a second preset rule; and
combining the rule indication information with the parameter table indication information to generate the option code.

5. The method according to claim 4, wherein said generating the rule indication information for indicating the obfuscation processing rule according to the first preset rule comprises:
assigning M different values to a preset array including M bytes, selecting values of first N bytes in the preset array, and determining a combination of the selected values of the first N bytes as the rule indication information; wherein one value in the selected values of the first N bytes is used to indicate one obfuscation processing rule; wherein each of the selected values is an integer ranging from 0 to (M−1), M and N are integers, and 0<N<M.

6. The method according to claim 5, wherein the rule indication information is a combination of values of the first N bytes in the preset array, and the values of the N bytes are N different integers; and
said generating, according to the second preset rule, the parameter table indication information for indicating the obfuscation processing parameter table, comprises:
randomly generating a random number having a length of N bytes, and determining the generated random number as the parameter table indication information, wherein one byte of data is used to indicate one obfuscation processing parameter table; and
wherein said combining the rule indication information with the parameter table indication information to generate the option code comprises:
traversing each byte of data in the random number having the length of N bytes, and performing, when the current byte of data is accessed, replacement operations including: selecting an unselected integer from the N integers, and replacing a low three-bit data of the current byte of data with a low three-bit data of the selected integer so as to obtain an operational byte data; wherein a high four-bit data of the obtained operational byte data is used for indicating the obfuscation processing parameter table, and the low three-bit data of the selected integer is used for indicating the obfuscation processing rule; and
determining a combination of obtained N operated byte data as the option code.

7. The method according to claim 1, wherein the obfuscation processing rule comprises at least one of following rules, including:
a rule for replacing characters included in a data with other characters;
a rule for performing a shift operation on the data;
a rule for performing an Exclusive OR on the data;
a rule for performing a coding operation on the data; and
a rule for assigning 1 to a first bit of data byte in bytes.

8. (canceled)

9. An electronic device, comprising a memory, a processor, and a computer program stored in the memory and executable by the processor, wherein when executing the computer program, the processor is configured to perform steps of a method for data protection, comprising:
selecting an obfuscation processing rule for performing a data obfuscation processing on the target data and an obfuscation processing parameter table adapted to the obfuscation processing rule, in response to receiving a target data; and
performing the data obfuscation processing on the target data according to the obfuscation processing rule and the obfuscation processing parameter table adapted to the obfuscation processing rule, so as to protect the target data.

10. A non-transitory computer-readable storage medium, which stores a computer program, that, when executed by a processor of an electronic device, causes the processor of the electronic device to implement steps of a method for data protection, comprising:
selecting an obfuscation processing rule for performing a data obfuscation processing on the target data and an obfuscation processing parameter table adapted to the obfuscation processing rule, in response to receiving a target data; and
performing the data obfuscation processing on the target data according to the obfuscation processing rule and the obfuscation processing parameter table adapted to the obfuscation processing rule, so as to protect the target data.

11. The electronic device according to claim 9, wherein the processor is particularly configured to perform the step of selecting the obfuscation processing rule for performing the data obfuscation processing on the target data and the obfuscation processing parameter table adapted to the obfuscation processing rule, by:
generating, according to a preset rule, an option code including rule indication information and parameter table indication information; wherein the rule indication information is used to indicate the obfuscation processing rule, and the parameter table indication information is used to indicate the obfuscation processing parameter table adapted to the obfuscation processing rule;
selecting the obfuscation processing rule indicated by the rule indication information, and selecting the obfuscation processing parameter table adapted to the obfuscation processing rule and indicated by the parameter table indication information.

12. The electronic device according to claim 9, wherein the processor is particularly configured to perform the step of performing the data obfuscation processing on the target data according to the obfuscation processing rule and the obfuscation processing parameter table adapted to the obfuscation processing rule, by:
determining a ranking of each of the plurality of obfuscation processing rules in response to a plurality of selected obfuscation processing rules; and
determining the target data as data to be obfuscated, and extracting a highest-ranked obfuscation processing rule from the plurality of obfuscation processing rules, and performing following processing steps, including: performing the data obfuscation processing on the data to be obfuscated using the extracted obfuscation processing rule and an obfuscation processing parameter table adapted to the extracted obfuscation processing rule; determining the obfuscated data as the data to be obfuscated, and extracting a highest-ranked obfuscation processing rule from unextracted obfuscation processing rules in response to a presence of the unextracted obfuscation processing rules in the plurality of obfuscation processing rules; and performing the processing steps cyclically.

13. The electronic device according to claim 11, wherein the processor is particularly configured to perform the step of generating, according to the preset rule, the option code including the rule indication information and the parameter table indication information, by:
generating the rule indication information for indicating the obfuscation processing rule according to a first preset rule, and generating the parameter table indication information for indicating the obfuscation processing parameter table according to a second preset rule; and
combining the rule indication information with the parameter table indication information to generate the option code.

14. The electronic device according to claim 13, wherein the processor is particularly configured to perform the step of generating the rule indication information for indicating the obfuscation processing rule according to the first preset rule, by:
assigning M different values to a preset array including M bytes, selecting values of first N bytes in the preset array, and determining a combination of the selected values of the first N bytes as the rule indication information; wherein one value in the selected values of the first N bytes is used to indicate one obfuscation processing rule; wherein each of the selected values is an integer ranging from 0 to (M−1), M and N are integers, and 0<N<M.

15. The electronic device according to claim 14, wherein the rule indication information is a combination of values of the first N bytes in the preset array, and the values of the N bytes are N different integers; and
the processor is particularly configured to perform the step of generating, according to the second preset rule, the parameter table indication information for indicating the obfuscation processing parameter table, by:
randomly generating a random number having a length of N bytes, and determining the generated random number as the parameter table indication information, wherein one byte of data is used to indicate one obfuscation processing parameter table; and
wherein the processor is particularly configured to perform the step of combining the rule indication information with the parameter table indication information to generate the option code, by:
traversing each byte of data in the random number having the length of N bytes, and performing, when the current byte of data is accessed, replacement operations including: selecting an unselected integer from the N integers, and replacing a low three-bit data of the current byte of data with a low three-bit data of the selected integer so as to obtain an operational byte data;
wherein a high four-bit data of the obtained operational byte data is used for indicating the obfuscation processing parameter table, and the low three-bit data of the selected integer is used for indicating the obfuscation processing rule; and
determining a combination of obtained N operated byte data as the option code.

16. The electronic device according to claim 9, wherein the obfuscation processing rule comprises at least one of following rules, including:
a rule for replacing characters included in a data with other characters;
a rule for performing a shift operation on the data;
a rule for performing an Exclusive OR on the data;
a rule for performing a coding operation on the data; and
a rule for assigning 1 to a first bit of data byte in bytes.
